(19) United States
(12) Patent Application Publication
(10) Pub. No.: US 2026/0336355 A1
(43) Pub. Date: Oct. 29, 2026

(54) Method for Operating a Refrigerant Circuit and Refrigerant Circuit

(71) Applicant: MAHLE International GmbH, Stuttgart (DE)

(72) Inventors: Mandeep Singh, TAMM (DE); Sascha Lindauer, Schorndorf (DE)

(21) Appl. No.: 19/657,160

(22) Filed: Apr. 24, 2026

(30) Foreign Application Priority Data
Apr. 25, 2025 (DE) 102025116010.4
Jun. 12, 2025 (DE) 102025123053.6

(51) Int. Cl. B60H 1/00; G01K 3/00

(52) U.S. Cl. CPC B60H 1/00321; B60H 1/00278; B60H 1/00485; B60H 1/00792; G01K 3/005

(57) ABSTRACT

A method for operating a refrigerant circuit in a system that also contains a cooling circuit is provided. The refrigerant circuit contains a first heat exchanger for air-conditioning a space, and a second heat exchanger for cooling a component with the cooling circuit. The refrigerant circuit is operated in an air-conditioning-prioritization mode when the first heat exchanger is given priority. The refrigerant circuit is operated in a component-prioritization mode when the second heat exchanger is given priority. A refrigerant circuit operated in this manner is also provided.

### CROSS-REFERENCE TO RELATED APPLICATIONS

This application claims priority from German Patent Application Numbers DE 102025116010.4 filed on Apr. 25, 2025 and DE 102025123053.6, filed on Jun. 12, 2025, the entirety of each is hereby incorporated by reference herein.

The present invention relates to a method for operating a refrigerant circuit in a system that also contains a cooling circuit. The invention also relates to a refrigerant circuit operated in this manner.

A refrigerant circulates through a refrigerant circuit. The refrigerant circuit is used for heat transfer, in particular as a heat pump. Consequently, the refrigerant circuit can discharge heat to a warmer area or component, or absorb heat from a colder area or component. This type of refrigerant circuit can be used in a system with a cooling circuit in which a coolant circulates. The coolant can be used to cool various components, e.g. a battery in a vehicle.

These refrigerant circuits, and these systems, are disclosed in DE 10 2021 204 471 A1, DE 11 2018 002 070 T5, and DE 11 2019 002 912 B4. These refrigerant circuits normally contain two heat exchangers, one of which uses a cooling circuit to cool a battery, and the other is used to air-condition a vehicle interior. The flow of refrigerant through the heat exchangers can be adjusted as needed.

The object of the present invention is to create a better, or at least different, method for operating such a refrigerant circuit, specifically with greater variability.

This is achieved by the subject matter of the independent Numbered Paragraphs. Advantageous embodiments are the subject matter of the dependent Numbered Paragraphs.

The present invention is based on the fundamental concept of operating two heat exchangers in a refrigerant circuit that are used for different applications in different operating modes with different priorities, such that in an operating mode that prioritizes one of the heat exchangers, most of the available thermal output is provided by the prioritized heat exchanger, and the rest is provided by the other heat exchanger. This makes is possible to entirely satisfy the thermal output demands on the prioritized heat exchanger, while the other heat exchanger provides any excess thermal output in the refrigerant circuit. This results in a more variable refrigerant circuit with an actual prioritization of the respective heat exchanger and therefore the resulting temperature control obtained therewith.

In accordance with the concept of the invention, the refrigerant circuit is part of a system that also contains a coolant circuit. Refrigerant circulates through the refrigerant circuit, when in use. Coolant circulates through the coolant circuit, when in use. The refrigerant circuit is referred to as a “refrigerant circuit” and the coolant circuit is referred to as a “cooling circuit.” A component is incorporated in the cooling circuit that is cooled and/or heated by the coolant. The component can be a battery, in particular an electric vehicle battery. The refrigerant circuit contains a compressor for the refrigerant. The compressor conveys the refrigerant through the refrigerant circuit. The refrigerant circuit also contains a first heat exchanger and a second heat exchanger. The first heat exchanger is in a first branch of the refrigerant circuit. The second heat exchanger is in a second, parallel branch of the refrigerant circuit. When in use, refrigerant flows through the first heat exchanger to cool air for air-conditioning a space, separately from the coolant or the air. The air is referred to as “conditioned air.” When in use, heat is exchanged in the first heat exchanger between the refrigerant and the coolant or the conditioned air in order to air-condition the space with the conditioned air. The space can be the interior of a vehicle. The coolant flows through the second heat exchanger, separately from the refrigerant, such that the refrigerant and coolant can exchange heat. Consequently, the coolant can be used to control the temperature of the battery. The second heat exchanger is therefore used to control the temperature of the component. The refrigerant circuit also contains a third heat exchanger that is downstream of the compressor and upstream of the first and second heat exchangers, specifically upstream of the first and second branches. The third heat exchanger is used specifically to cool the refrigerant. The first and second heat exchangers each have dedicated expansion valves for regulating the flow of refrigerant through them. This means that the refrigerant circuit has a first expansion valve for regulating the flow of refrigerant through the first heat exchanger, and a second expansion valve for regulating the flow of refrigerant through the second heat exchanger. The refrigerant circuit can provide a maximum thermal output at the first and second heat exchangers, which is referred to below as the “maximum thermal output” or “maximum output.” If the maximum output is insufficient for the demands on the first and second heat exchangers, one of the heat exchangers is prioritized, depending on the operating mode. This means that if the sum of the thermal output required by the first heat exchanger, also rereferred to as the “first thermal output,” and by the second heat exchanger, also referred to as the “second thermal output,” exceeds the maximum output, the refrigerant circuit can be operated in an air-conditioning-prioritizing mode, or a component-prioritizing mode. In the air-conditioning-prioritizing mode, the first heat exchanger is prioritized. This means that the first thermal output required of the first heat exchanger is provided by the first heat exchanger, and the second heat exchanger is able to provide any excess thermal output. When in the component-prioritizing mode, the second thermal output required of the second heat exchanger is provided by the second heat exchanger, and the first heat exchanger is able to provide any remaining thermal output from the maximum output.

The third heat exchanger is used to control the temperature of the refrigerant. For this, another fluid flows separately from the refrigerant through the third heat exchanger. The other fluid can be fresh air or the coolant.

The compressor divides the refrigerant into an output side downstream of the compressor, extending to the expansion valves, and an intake side upstream of the compressor, extending to the expansion valves. This means that the first and second heat exchangers are in the intake side. The third heat exchanger is in the output side.

The thermal output provided by the first heat exchanger can theoretically be set arbitrarily.

In preferred embodiments, the thermal output of the first heat exchanger can be set by adjusting the compressor output. The compressor output can be set by adjusting the speed of the compressor, specifically the speed at which the mechanism for compressing the refrigerant rotates, wherein higher speeds correspond to higher outputs, and vice versa. To increase the thermal output from the first heat exchanger, the power, e.g. electricity, supplied to the compressor is increased.

It is also possible to set the thermal output of the first heat exchanger by adjusting the first expansion valve. This involves opening the first expansion valve further, thus enlarging the open cross section therein. To reduce the thermal output from the first heat exchanger, the open cross section of the first expansion valve can be reduced.

The thermal output provided by the second heat exchanger can theoretically be set arbitrarily.

In preferred embodiments, the thermal output of the second heat exchanger can be set by adjusting the second expansion valve. To increase the thermal output of the second heat exchanger, the second expansion valve is opened further, thus enlarging the open cross section thereof. To reduce the thermal output of the second heat exchanger, the open cross section of the second expansion valve can be reduced.

It is assumed in the following that the thermal outputs required of and provided by the first and second heat exchangers are for cooling the conditioned air with the first heat exchanger and cooling the component with the second heat exchanger. The same applies to the maximum output, if maximum cooling of the cooling circuit is required by the first and second heat exchangers.

In the air-conditioning-prioritization mode, the size of the open cross section of the second expansion valve is preferably limited if the temperature of the coolant downstream of the first heat exchanger, in particular at a coolant outlet on the first heat exchanger, and/or the temperature of the conditioned air downstream of the first heat exchanger, exceeds a target temperature by a predefined first limit value. This target temperature is also referred to below as the first target temperature. The first target temperature is the temperature necessary for cooling the space. The thermal output at the second heat exchanger is reduced in this manner if the thermal output of the first heat exchanger is unable to cool the space adequately. This is a prioritization of the first heat exchanger, and thus the cooling of the conditioned air, and therefore the space. This limitation is removed if the temperature of the coolant downstream of the first heat exchanger, in particular at the coolant outlet on the first heat exchanger, and/or the temperature of the conditioned air downstream of the first heat exchanger, falls below the first target temperature by a predefined second limit value. If the demanded cooling for the conditioned air is obtained and exceeded, then the second heat exchanger can also provide more thermal/cooling output.

The first and second limit values can theoretically be selected arbitrarily.

The first limit value is preferably between 0.5 K and 2 K, specifically 1 K. The second limit value is preferably between 0.1 K and 1 K, ideally 0.5 K. These values have proven to be advantageous, because they do not result in any noticeable and undesirable abrupt changes in temperature in the air-conditioning-prioritization mode. This improves the overall impression of the air-conditioning system in this mode.

The refrigerant can be present in the gaseous phase or liquid phase. It can also be mixed, such that some of the refrigerant is in the gaseous phase, and some is in the liquid phase. These phases depend on the temperature and pressure of the refrigerant. The mixed phase transitions to the gaseous phase when the saturation temperature is exceeded. “Superheating” refers to when the temperature exceeds the saturation temperature. If the refrigerant is superheated, it is in the gaseous phase.

When refrigerant flows through the first and second heat exchangers, the size of the open cross section of the second expansion valve is limited in the air-conditioning-prioritization mode and/or in the component-prioritization mode if the superheating of the refrigerant downstream of the second heat exchanger, in particular at a refrigerant outlet on the second heat exchanger, falls below a predefined minimum for the superheating by a predefined third limit value. This minimum is at least the saturation temperature of the refrigerant. The minimum is preferably above the saturation temperature. The third limit value cannot exceed the difference between the minimum and the saturation temperature of the refrigerant. The limitation on the size of the open cross section of the second expansion valve prevents or reduces the temperature from falling below the saturation temperature, thus damaging the refrigerant circuit and/or disrupting the functioning thereof. This limitation is removed if the superheating exceeds the minimum by a predefined fourth limit value. The limitation on the size of the open cross section of the second heat exchanger is removed if there is no more threat of falling below the saturation temperature.

The minimum, third limit value, and fourth limit value can theoretically be selected arbitrarily.

The minimum can be between 1 K and 5 K above the saturation temperature. In particular, the minimum is 3 K above the saturation temperature. The third limit value is preferably between 1 K and 3 K, in particular 2 K. The fourth limit value is preferably between 1 K and 3 K, in particular 2 K. These values increase the efficiency of the refrigerant circuit resulting in its functioning reliably.

Embodiments are preferred in which the size of the open cross section of the first expansion valve is limited in the component-prioritization mode if the temperature of the coolant downstream of the second heat exchanger, in particular in a coolant outlet on the second heat exchanger, exceeds a target temperature by a predefined fifth limit value. This target temperature is also referred to below as the “second target temperature.” By limiting the size of the open cross section of the first expansion valve, the available cooling output is shifted from the first to the second heat exchanger. The limitation is removed when the temperature of the coolant downstream of the second heat exchanger, in particular at the coolant outlet thereon, falls below the second target temperature by a predefined sixth limit value.

The second target temperature is preferably the temperature of the coolant necessary for cooling the component, in particular a battery.

The fifth and sixth limit values can theoretically be selected arbitrarily. The fifth limit value is preferably at least 1 K. In particular, the fifth limit value is 2 K. The sixth limit value is preferably between 0.1 K and 3 K. In particular, the sixth limit value is 1 K.

Placing a limit on the size of the open cross section of the respective expansion valve means that the expansion valve can be opened up to this limit. This limit is temporary, and removing this limitation means that the expansion valve can then be adjusted within its intrinsic limitations.

The limitation can be established with limits stored in a control unit for the second expansion valve, such that the size of the open cross section, in particular the maximum possible size of the open cross section and thus a corresponding maximum setting, is temporarily overwritten.

The method can be implemented in a refrigerant circuit by a control unit of the appropriate type. This means that the refrigerant circuit can contain a control unit designed for operating the refrigerant circuit. This control unit can communicate with at least one of the expansion valves and the compressor.

The refrigerant circuit can also contain at least one sensor for detecting the temperature of the refrigerant circuit and/or the pressure of the refrigerant. The at least one sensor can communicate with the control unit.

It is understood that in addition to the method for operating the refrigerant circuit, the refrigerant circuit is also part if this invention.

Important features and advantages of the invention can be derived from the dependent claims, drawings, and descriptions of the drawings.

It is understood that the features specified above and explained below can be used not only in the given combinations, but also in other combinations or in and of themselves, without abandoning the scope of protection for the invention. Components in a higher-order unit, e.g. an element, device, or assembly, that are indicated separately, can be separate parts or components of this unit, or integral parts or sections thereof, even if otherwise indicated in the drawings.

Preferred exemplary embodiments of the invention are shown in the drawings and shall be explained below in greater detail, in which the same reference symbols are used for the same, similar, or functionally identical components.

Therein, schematically

FIG. 1 shows a highly simplified circuit diagram of a refrigerant circuit in a system that also contains a cooling circuit,

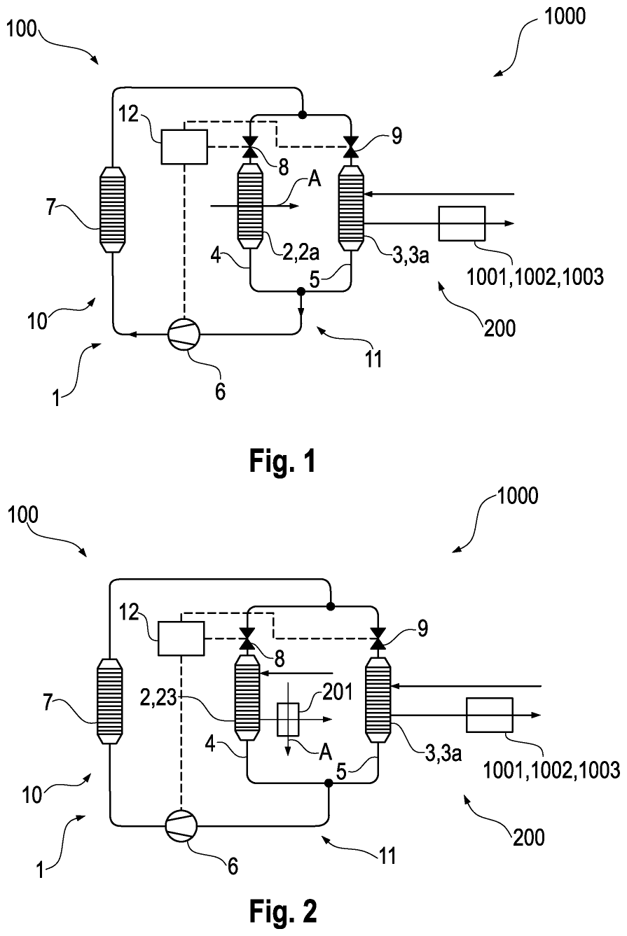

FIG. 2 shows another exemplary embodiment of a highly simplified circuit diagram of a refrigerant circuit in a system,

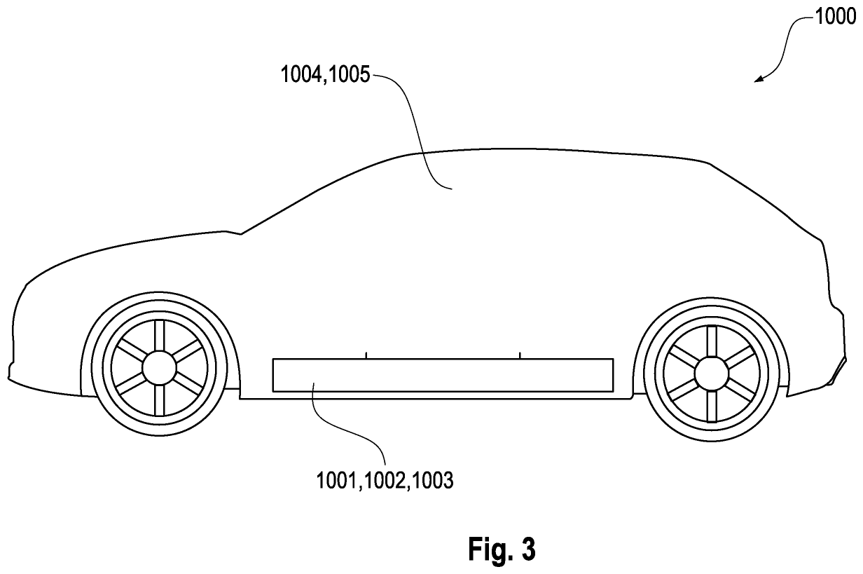

FIG. 3 shows a highly simplified side view of a vehicle that has the refrigerant circuit,

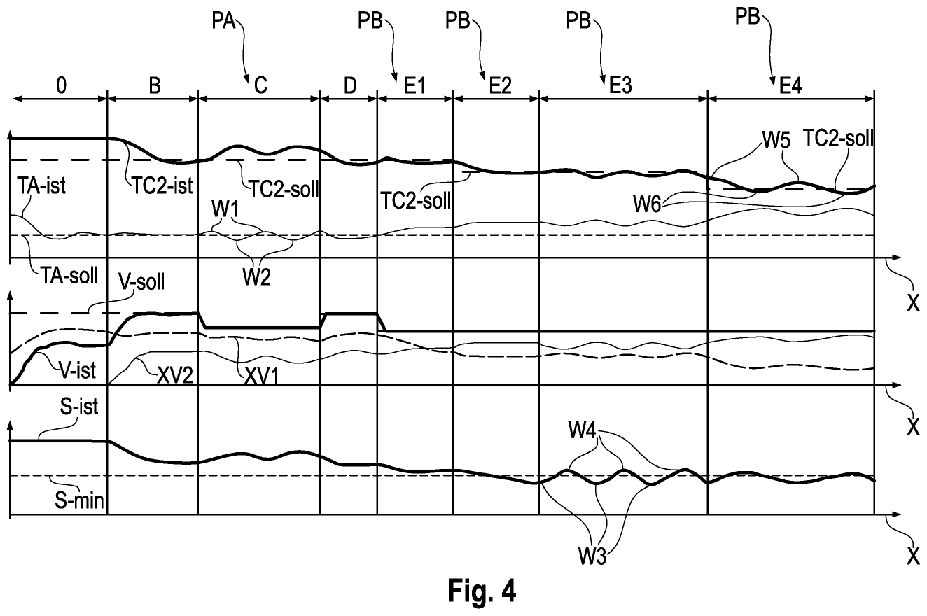

FIG. 4 a graph used to explain a method for operating the refrigerant circuit.

A refrigerant circulates through the exemplary refrigerant circuit 1 shown in FIGS. 1 and 2. The refrigerant circuit 1 contains a first heat exchanger 2 and a second heat exchanger 3. The first heat exchanger 2 is in a first branch 4 of the refrigerant circuit 1, and the second heat exchanger 3 is in a parallel second branch 5 of the refrigerant circuit 1. The refrigerant circuit 1 also contains a compressor 6 for the refrigerant and a third heat exchanger 7. The third heat exchanger 7 is downstream of the compressor 6 and upstream of the first and second heat exchangers 2, 3, and therefore upstream of the first and second branches 4, 5. The third heat exchanger 7 is used to cool the refrigerant. The third heat exchanger 7 can be a refrigerant/air heat exchanger, or a refrigerant/coolant heat exchanger. The refrigerant circuit 1 also contains a first expansion valve 8 for regulating the flow of refrigerant through the first heat exchanger 2 and a second expansion valve 9 for regulating the flow of refrigerant through the second heat exchanger 3, both of which are upstream of their respective heat exchangers 2, 3. In these exemplary embodiments, the first expansion valve 8 is in the first branch 4, and the second expansion valve 9 is in the second branch 5. The compressor 6 compresses the refrigerant. The compressor 6 therefore divides the refrigerant circuit 1 into an output side 10 downstream of the compressor 6 and extending to the expansion valves 8, 9, and an intake side 11 upstream of the compressor 6 and extending to the expansion valves 8, 9. In these exemplary embodiments, the first and second heat exchangers 2, 3 are therefore in the intake side 11 and the third heat exchanger 7 is in the output side 10 of the refrigerant circuit 1.

The refrigerant can be in the gaseous phase, liquid phase, or a mixture thereof, depending on the temperature and pressure of the refrigerant. In the mixed phase, the refrigerant is in both the gaseous and liquid phases. If the saturation temperature is exceeded, the refrigerant transitions to the gaseous phase. When the refrigerant is above the saturation temperature, it is superheated. If the refrigerant is superheated, the refrigerant is in the gaseous phase.

The refrigerant circuit 1 is used in a system 100, as shown in FIGS. 1 and 2, that also contains a coolant circuit 200 through which coolant circulates. The coolant circuit 200 is also referred to as a “cooling circuit” 200. At least one component 1001 is incorporated in the cooling circuit 200, which is cooled by the coolant. The component 1001 can be for a vehicle 1000 (see FIG. 3). By way of example, the component 1001 can be a battery 1002, in particular an electric vehicle battery 1003, see FIG. 3.

The first heat exchanger 2 is used to cool air A, indicated by an arrow in FIGS. 1 and 2, which is also referred to as “conditioned air” A herein. The conditioned air A is used to air-condition a space 1004 (see FIG. 3), the passenger compartment 1005 of the vehicle 1000 in the exemplary embodiment shown in FIG. 3. The conditioned air A is cooled by the first heat exchanger 2, as shown in FIG. 1, when the conditioned air A flows through the first heat exchanger 2, separately from the refrigerant. In this case, the first heat exchanger 2 is a refrigerant/air heat exchanger 2a. The air A can also be cooled by the first heat exchanger 2 when the coolant flows through the first heat exchanger 2 separately from the refrigerant. This means that the conditioned air A is cooled by the coolant. In this case, the first heat exchanger 2 is a refrigerant/coolant heat exchanger 2b. In this case, the first heat exchanger 2 is also a heat exchanger 2 for the cooling circuit 200. The conditioned air A then flows separately from the refrigerant through a heat exchanger 201 in the cooling circuit 200, referred to as an “air cooler” 201 for purposes of clarity.

The second heat exchanger 3 is used to cool the component 1001. For this, coolant flows through the second heat exchanger 3, separately from the refrigerant. The second heat exchanger 3 is therefore a refrigerant/coolant heat exchanger 3a. The second heat exchanger 3 is in both the refrigerant circuit 1 and the cooling circuit 200.

The refrigerant circuit 1 has a maximum thermal output from the first heat exchanger 2 and second heat exchanger 3, also referred to as the “maximum thermal output” or simply the “maximum output.” A thermal output may be demanded of the first heat exchanger 2 for cooling the conditioned air A, which is then referred to as the “first thermal output.” A thermal output may also be demanded of the second heat exchanger 2 for cooling the component 1001, which is then referred to as the “second thermal output.” These thermal outputs are for cooling in each case. It shall be assumed below, by way of example and for purposes of clarity, that the thermal outputs are for cooling purposes.

The thermal output of the first heat exchanger 2 can be set by adjusting the output, specifically the speed V, of the compressor 6. This thermal output can also be set by adjusting the first expansion valve 8, and thus altering the size of the open cross section in the first expansion valve 8.

The thermal output of the second heat exchanger 3 can be set by adjusting the second expansion valve 9, and thus by adjusting the size of the open cross section in the second expansion valve 9.

These adjustments can be made by a control unit 12 for the refrigerant circuit that is connected to the compressor 6 and at least one of the expansion valves 8, 9. These connections are indicated in FIGS. 1 and 2 by broken lines. The refrigerant circuit 1 and/or system 100 can also contain at least one sensor for detecting the temperature and/or the pressure of the refrigerant and/or coolant. This control unit 12 can ideally communicate with the at least one sensor. The control unit 12 is designed to execute the method described herein.

As shall be explained in reference to FIG. 4, the refrigerant circuit 1 can prioritize cooling the conditioned air A with the first heat exchanger 2, or the component 1001 with the second heat exchanger 3, if the sum of the first thermal output, from the first heat exchanger 2, and second thermal output, from the second heat exchanger 3, is greater than the maximum thermal output. The refrigerant circuit 1 would then be operated in either a mode that prioritizes the first heat exchanger 2, referred to as the air-conditioning-prioritizing mode PA, or in a mode that prioritizes the second heat exchanger 3, referred to as the component-prioritizing mode PB. The demanded first thermal output is therefore provided by the first heat exchanger 2 in the air-conditioning-prioritizing mode PA, and any excess thermal output from the maximum output is provided by the second heat exchanger 3. In the component-prioritizing mode PB, the demanded second thermal output is provided by the second heat exchanger 3, and any excess thermal output from the maximum output is provided by the first heat exchanger 2.

FIG. 4 shows a temporal course of the operation of the refrigerant 1 in an exemplary scenario. There are three graphs in FIG. 4. Each graph plots time along the X-axis.

In the upper graph in FIG. 4, the thinner lines indicate the temporal course of the temperature of the conditioned air A, and thus the cooling from the first heat exchanger 2. The continuous thinner line is the actual temperature TA_ist of the conditioned air A, and the broken thinner line is the target temperature TA_soll for this conditioned air A. The target temperature TA_soll is also referred to as the “first target temperature” TA_soll. The actual temperature TA_ist and the first target temperature TA_soll can be determined downstream of the first heat exchanger 2, in particular if the first heat exchanger 2 is a refrigerant/air heat exchanger 2a, see FIG. 1. A similar course would be obtained if the first heat exchanger 2 were a refrigerant/coolant heat exchanger 2b, see FIG. 2, in which case the temperature of the coolant downstream of the first heat exchanger 2, in particular at a coolant outlet on the first heat exchanger 2 (not shown), were plotted.

The upper graph in FIG. 4 also shows the course of the temperature of the coolant downstream of the second heat exchanger 3, in particular at a coolant outlet (not shown) on the second heat exchanger 3, thus also indicating the cooling output of the second heat exchanger 3. In particular, the thicker lines indicate the temperature of the coolant at a coolant outlet on the second heat exchanger 3 (not shown). The continuous thick line indicates the actual temperature TC2_ist of the coolant and the broken thick line indicates a target temperature TC2_soll, and therefore the target temperature for the coolant downstream of the second heat exchanger 3, in particular at the coolant outlet on the second heat exchanger 3. The target temperature TC2_soll is also referred to as the “second target temperature” TC2_soll.

The middle graph in FIG. 4 shows the temporal course of the speed of the compressor 6 and thus the output of the compressor 6 with the thicker lines. The continuous thicker line indicates the actual speed V_ist and the broken thinner line is the target speed V_soll of the compressor 6. The middle graph in FIG. 4 also plots, with the thinner broken line, the temporal course of the setting XV1 of the first expansion valve 8 and thus the open cross section thereof. It is assumed that raising the setting XV1 enlarges the open cross section of the first expansion valve 8. The middle graph in FIG. 4 also plots the temporal course of the setting XV2 of the second expansion valve 9, and thus the open cross section thereof, with the thinner continuous line. It is assumed that raising the setting XV2 enlarges the open cross section of the second expansion valve 9.

The lower graph in FIG. 4 shows the temporal course of the superheating of the refrigerant downstream of the second heat exchanger 3, in particular at a refrigerant outlet (not shown) on the second heat exchanger 3. The continuous line plots the actual value S_ist of the superheating, and the broken line plots a predefined minimum S_min for the superheating. It is assumed that the thermal output is a cooling output.

A limit can be placed on the size of the open cross section of the second expansion in the air-conditioning-prioritization mode PA, if the temperature TA_ist of the conditioned air A downstream of the first heat exchanger 2 exceeds the first target temperature TA_soll by a predefined first limit value W1. This means that the size of the open cross section of the second expansion valve 9, and therefore the setting XV2 thereof, can be adjusted between a minimum and a maximum, which has a limit setting, if the temperature TA_ist of the conditioned air A exceeds the first target temperature TA_soll by a predefined limit value W1. Consequently, the cooling output from the second heat exchanger 3 is limited, such that the first heat exchanger 2 has priority. Consequently, the temperature TA_ist of the conditioned air A decreases. The temperature TC2_ist of the coolant downstream of the second heat exchanger 3 will then increase, and the second target temperature TC2_soll will also increase. The limitation on the size of the open cross section in the second expansion valve 9 is removed if the temperature TA_ist for the conditioned air A falls below the first target temperature TA_soll by a predefined second limit value W2. At this point, the second heat exchanger 3 can then provide more cooling output. Consequently, the temperature TA_ist of the conditioned air A can increase, in particular to above the first limit value W1 TA_target. If this is the case, the size of the open cross section of the second expansion valve 9 is again limited, until the temperature falls below first target temperature TA_soll by the second limit value W2. The limitation on the size of the open cross section of the second expansion valve 9, and therefore the limitation on the setting XV2 of the second expansion valve 9, can be obtained by temporarily overwriting the limits for the maximum size of the open cross section, or the highest setting XV2, in a control unit (not shown) for the second expansion valve XV2.

The first limit value W1 is between 0.5 K and 2 K, for example. Specifically, the first limit value W1 can be 1 K. The second limit value W2 is between 0.1 K and 1 K, for example. Specifically, this second limit value W2 can be 0.5 K.

Like the limitation on the size of the open cross section in the second expansion valve 9 in the air-conditioning-prioritization mode PA, the size of the open cross section in the first expansion valve 8 can be limited in the component-prioritization mode PB. The phase for this component-prioritization mode PD is indicated in FIG. 4 by “E4.” In this case, the size of the open cross section in the first expansion valve 8 is limited, if the temperature TC2_ist of the coolant downstream of the second heat exchanger 3, in particular at a coolant outlet (not shown) in the second heat exchanger 3, exceeds the second target temperature TC2_soll by a predefined fifth limit value W5. This limitation is removed if the temperature TC2_ist of the coolant falls below the second target temperature TC2_soll by a predefined sixth limit value W6. The fifth limit value W5 is ideally at least 1 K. In particular, the fifth limit value W5 is 2 K. The sixth limit value W6 can be between 0.1 K and 3 K. Ideally, the sixth limit value W6 is 1K.

As FIG. 4 shows, the size of the open cross section in the second expansion valve 9 can also be limited in the component-prioritization mode PB if the superheating S_ist downstream of the second heat exchanger 3, in particular at the refrigerant outlet (not shown) on the second heat exchanger 3, falls below the minimum S_min by a predefined third limit value W3. This increases the superheating S_ist, as can be seen in FIG. 4. The limitation is removed if the superheating S_ist exceeds the minimum S_min by a predefined fourth limit value W4. This limitation is implemented if use of the superheating in the second heat exchanger 3 is activated, specifically if the second heat exchanger 3 is to absorb heat. This use is not continuously activated in the exemplary embodiment in FIG. 4, but only in the second-to-last phase of the component-prioritization mode PB in FIG. 4, indicated by “E3.” A similar limitation on the size of the open cross section in the second expansion valve 9 can also be obtained in the air-conditioning-prioritization mode PA (not shown).

The minimum can be between 1 K and 5 K above the saturation temperature. Specifically, the minimum is 3 K above the saturation temperature. The third limit value W3 can be between 1 K and 3 K. Specifically, the third limit value W3 is 2 K. The fourth limit value W4 can be between 1 K and 3 K. Specifically, the fourth limit value W4 is 2 K.

The following is assumed in FIG. 4. It starts with initiating the refrigerant circuit 1, specifically the system 100, at which point the phase of the initiation and the start-up is indicated in FIG. 4 by “0.” It is assumed that in the initiating phase 0, all that is required is air-conditioning of the space 1004, i.e. cooling by the first heat exchanger 2. In this phase 0, the speed V_ist of the compressor 6 is increased, lowering the temperature TA_ist of the conditioned air A. the temperature TC2_ist remains constant, specifically because the setting XV2 for the second expansion valve 9 remains constant. In a second phase B, following the initiation phase 0, it is assumed that both the first and second heat exchangers 2, 3 are to provide a cooling output. This means that in the second phase B, the space 1004 is to be air-conditioned, and the component 1001 is to be cooled. At this point, the maximum thermal output is not exceeded by the cooling output required of the first heat exchanger 2 and second heat exchanger 3.

Phase B is followed by a third phase C, at which point the cooling output required of the first and second heat exchangers 2, 3 exceeds the maximum thermal output. This may be because the target speed V_soll of the compressor 6 is limited. In this case, the refrigerant circuit 1 in the exemplary embodiment shown in FIG. 4 is operated in phase C in the air-conditioning-prioritization mode PA.

The third phase C is followed by a fourth phase D, in which the maximum thermal output is sufficient for the cooling requirements of the first and second heat exchangers 2, 3, e.g. because the speed V_ist of the compressor 6 has been increased.

Phases E1, E2, E3, and E4 follow phase D, in which the maximum thermal output is insufficient for the cooling needs of the first and second heat exchangers 2, 3, e.g. due to a decrease in the target speed V_soll of the compressor 6. In these phases, E1, E2, E3, and E4, the refrigerant circuit 1 is operated in the component-prioritization mode PB. It is assumed that in phases E1 and E2, the user of the superheating limit is deactivated in the second heat exchanger 3, and it is activated in phases E3 and E4. It is also assumed that in phases E2 and E3, the target temperature TC2_soll is lower than in the previous phase. It is also assumed that the target temperature TC2_soll in phase E4 is lower than in phase E3.

The specification can be readily understood with reference to the following numbered paragraphs:
Numbered Paragraph 1. A method for operating a refrigerant circuit (1) in a system (100) comprising the refrigerant circuit (1) through which a refrigerant circulates, and a cooling circuit (200) through which a coolant circulates, wherein at least one component (1001) is incorporated in the cooling circuit (200), in particular a battery (1002), which is cooled by the coolant, wherein
   the refrigerant circuit (1) contains a compressor (6) for the refrigerant,
   the refrigerant circuit (1) contains a first heat exchanger (2) in a first branch (4) of the refrigerant circuit (1) through which refrigerant flows separately from coolant or conditioned air (A) to cool the conditioned air (A) for an air-conditioned space (1004), and a second heat exchanger (3) in a second branch (5) of the refrigerant circuit (1) that is parallel to the first branch (4), and through which the coolant flows separately from the refrigerant, such that the two exchange heat,
   the refrigerant circuit (1) contains a third heat exchanger (6), which is downstream of the compressor (6) and upstream of the first and second heat exchangers (2, 3),
   there is a first expansion valve (8) for regulating the flow of refrigerant through the first heat exchanger (2),
   there is a second expansion valve (9) for regulating the flow of refrigerant through the second heat exchanger (3),
   the refrigerant circuit (1) has a maximum thermal output from the first and second heat exchangers (2, 3),
   if the sum of the thermal outputs required of the first and second heat exchangers (2, 3) exceeds the maximum thermal output,
      the first thermal output required of the first heat exchanger (2) is supplied by the first heat exchanger (2) in an air-conditioning-prioritization mode (PA), and any excess thermal output is supplied by the second heat exchanger (3),
      the second thermal output required of the second heat exchanger (3) is supplied by the second heat exchanger (3) in a component-prioritization mode (PB), and any excess thermal output is supplied by the first heat exchanger (2).
Numbered Paragraph 2. The method according to Numbered Paragraph 1, characterized in that the thermal output of the first heat exchanger (1) is set by adjusting the output of the compressor (6).
Numbered Paragraph 3. The method according to Numbered Paragraph 2, characterized in that the thermal output of the second heat exchanger (3) is set by adjusting the second expansion valve (9).
Numbered Paragraph 4. The method according to any of the Numbered Paragraphs 1 to 3, characterized in that in the air-conditioning-prioritization mode (PA):
   a limit is placed on the size of the open cross section in the second expansion valve (9), if the temperature of the coolant downstream of the first heat exchanger (2), in particular at a coolant outlet on the first heat exchanger (2), and/or the temperature (TA_ist) of the conditioned air (A) downstream of the first heat exchanger (2) exceeds a first target temperature (TA_soll) by a predefined first limit value (W1),
   the limit is removed when the temperature of the coolant downstream of the first heat exchanger (2), in particular at the coolant outlet on the first heat exchanger (2), and/or the temperature (TA_ist) of the conditioned air (A) below the first heat exchanger (2), falls below the first target temperature (TA_soll) by a predefined second limit value (W2).
Numbered Paragraph 5. The method according to Numbered Paragraph 4, characterized in that
   the first limit value (W1) is between 0.5 K and 2 K, specifically 1 K, and/or
   the second limit value (W2) is between 0.1 K and 1 K, specifically 0.5 K.
Numbered Paragraph 6. The method according to any of the Numbered Paragraphs 3 to 5, characterized in that in the air-conditioning-prioritization mode (PA) and/or in the component-prioritization mode (PB),
   a limit is placed on the size of the open cross section of the second expansion valve (9) if superheating (S_ist) of the refrigerant downstream of the second heat exchanger (3), in particular at a refrigerant outlet on the second heat exchanger (3), falls below a predefined minimum (S_min) by a predefined third limit value (W3), wherein the minimum (S_min) is at least the saturation temperature of the refrigerant, and the third limit value (W3) is no more than the difference between the minimum (S_min) and the saturation temperature of the refrigerant,
   the limit is removed when the superheating (S_ist) exceeds the minimum (S_min) by a predefined fourth limit value (W4).
Numbered Paragraph 7. The method according to Numbered Paragraph 6, characterized in that
   the minimum (S_min) is between 1 K and 5 K, specifically 3 K,
   the third limit value (W3) is between 1 K and 3 K, specifically 2 K, and/or
   the fourth limit value (W4) is between 1 K and 3 K, specifically 2 K.
Numbered Paragraph 8. The method according to any of the Numbered Paragraphs 1 to 7, characterized in that in the component-prioritization mode (PB):
   a limit is placed on the size of the open cross section in the first expansion valve (8) if the temperature (TC2_ist) of the coolant downstream of the second heat exchanger (3), in particular at a coolant outlet in the second heat exchanger (3), exceeds a second target temperature (TC2_soll) by a predefined fifth limit value (W5),
   the limit is removed when the temperature (TC2_ist) of the coolant downstream of the second heat exchanger (3), in particular at the coolant outlet on the second heat exchanger (3), falls below the second target temperature (TC2_soll) by a predefined sixth limit value (W6).
Numbered Paragraph 9. The method according to Numbered Paragraph 8, characterized in that
   the fifth limit value (W5) is at least 1 K, specifically 2 K, and/or
   the sixth limit value (W6) is between 0.1 K and 3 K, specifically 1 K.
Numbered Paragraph 10. A refrigerant circuit (1) for a system (100) comprising the refrigerant circuit (1) through which a refrigerant circulates, and a coolant circuit (200) through which a coolant circulates, wherein at least one component (1001) is incorporated in the cooling circuit (200), in particular a battery (1002), which is cooled by the coolant, wherein
   the refrigerant circuit (1) contains a compressor (6) for the refrigerant,
   the refrigerant circuit (1) contains a first heat exchanger (2) in a first branch (4) of the refrigerant circuit (1) through which refrigerant flows separately from coolant or conditioned air (A) to cool the conditioned air (A) for an air-conditioned space (1004), and a second heat exchanger (3) in a second branch (5) of the refrigerant circuit (1) that is parallel to the first branch (4), and through which the coolant flows separately from the refrigerant, such that the two exchange heat,
   the refrigerant circuit (1) contains a third heat exchanger (6), which is downstream of the compressor (6) and upstream of the first and second heat exchangers (2, 3),
   there is a first expansion valve (8) for regulating the flow of refrigerant through the first heat exchanger (2),
   there is a second expansion valve (9) for regulating the flow of refrigerant through the second heat exchanger (3),
   the refrigerant circuit (1) has a maximum thermal output from the first and second heat exchangers (2, 3),
      there is a control unit (12) that operates the refrigerant circuit (1) with the method according any of the preceding Numbered Paragraphs.

### LIST OF REFERENCE SYMBOLS

1 refrigerant circuit
2 first heat exchanger
2a refrigerant/air heat exchanger
2b refrigerant/coolant heat exchanger
3 second heat exchanger
3a refrigerant/coolant heat exchanger
4 first branch
5 second branch
6 compressor
7 third heat exchanger
8 first expansion valve
9 second expansion valve
10 output side
11 intake side
12 control unit
100 system
200 cooling circuit
201 air cooler
1000 vehicle
1001 component
1002 battery
1003 electric vehicle battery
1004 space
1005 passenger compartment
A conditioned air
PA air-conditioning-prioritization mode
PB component-prioritization mode
S_ist actual value for superheating of refrigerant
S_min minimum for superheating
TA_ist actual temperature of the conditioned air
TA_soll first target temperature
TC2_ist actual temperature of the coolant
TC2_soll second target temperature
V_ist actual speed of the compressor
V_soll target speed of the compressor
W1 first limit value
W2 second limit value
W3 third limit value
W4 fourth limit value
W5 fifth limit value
W6 sixth limit value
X horizontal axis
XV1 setting of first expansion valve
XV2 setting of second expansion valve

1-10. (canceled)

11. A method for operating a refrigerant circuit in a system comprising the refrigerant circuit through which a refrigerant circulates, and a cooling circuit through which a coolant circulates, wherein a battery is provided that is cooled by the cooling circuit, wherein
the refrigerant circuit comprises:
a compressor configured for compressing for the refrigerant,
a first heat exchanger in a first branch of the refrigerant circuit through which refrigerant flows separately from coolant or conditioned air to cool the conditioned air for an air-conditioned space,
a second heat exchanger in a second branch of the refrigerant circuit that is parallel to the first branch, and through which the coolant flows separately from the refrigerant, such that the two exchange heat,
a third heat exchanger, which is downstream of the compressor and upstream of the first and second heat exchangers,
a first expansion valve configured for regulating the flow of refrigerant through the first heat exchanger, and
a second expansion valve configured for regulating the flow of refrigerant through the second heat exchanger,
wherein the refrigerant circuit has a maximum thermal output from the first and second heat exchangers,
wherein if the sum of the thermal outputs required of the first and second heat exchangers exceeds the maximum thermal output,
the first thermal output required of the first heat exchanger is supplied by the first heat exchanger in an air-conditioning-prioritization mode (PA), and any excess thermal output is supplied by the second heat exchanger, or
the second thermal output required of the second heat exchanger is supplied by the second heat exchanger in a component-prioritization mode (PB), and any excess thermal output is supplied by the first heat exchanger.

12. The method according to claim 11, wherein the thermal output of the first heat exchanger is set by adjusting the output of the compressor.

13. The method according to claim 12, wherein the thermal output of the second heat exchanger is set by adjusting the second expansion valve.

14. The method according to claim 11, wherein in the air-conditioning-prioritization mode (PA):
placing a limit on a size of an open cross section in the second expansion valve, if the temperature of the coolant downstream of coolant outlet of the first heat exchanger, and/or the temperature (TA_ist) of the conditioned air downstream of the first heat exchanger exceeds a first target temperature (TA_soll) by a predefined first limit value,
removing the limit on the size of the open cross section in the second expansion valve when the temperature of the coolant downstream of the coolant outlet of the first heat exchanger, and/or the temperature (TA_ist) of the conditioned air below the first heat exchanger, falls below the first target temperature (TA_soll) by a predefined second limit value.

15. The method according to claim 14, wherein the first limit value is between 0.5 K and 2 K, and/or the second limit value is between 0.1 K and 1 K.

16. The method according to claim 13, wherein in the air-conditioning-prioritization mode (PA) and/or in the component-prioritization mode (PB),
placing a limit on the size of the open cross section of the second expansion valve if superheating (S_ist) of the refrigerant downstream of the refrigerant outlet second heat exchanger, falls below a predefined minimum (S_min) by a predefined third limit value, wherein the minimum (S_min) is at least the saturation temperature of the refrigerant, and the third limit value is no more than the difference between the minimum (S_min) and the saturation temperature of the refrigerant,
removing the limit when the superheating (S_ist) exceeds the minimum (S_min) by a predefined fourth limit value.

17. The method according to claim 16, wherein the minimum (S_min) is between 1 K and 5 K, the third limit value is between 1 K and 3 K, and/or the fourth limit value is between 1 K and 3 K.

18. The method according to claim 11, wherein in the component-prioritization mode (PB):
placing a limit on the size of the open cross section in the first expansion valve if the temperature (TC2_ist) of the coolant downstream of the coolant outlet in the second heat exchanger exceeds a second target temperature (TC2_soll) by a predefined fifth limit value,
removing the limit when the temperature (TC2_ist) of the coolant downstream of the coolant outlet on the second heat exchanger, falls below the second target temperature (TC2_soll) by a predefined sixth limit value.

19. The method according to claim 18, wherein the fifth limit value is at least 1 K, and/or the sixth limit value is between 0.1 K and 3 K.

20. A refrigerant circuit for a system comprising the refrigerant circuit through which a refrigerant circulates, and the coolant circuit through which a coolant circulates, wherein at least one component (1001) is incorporated in the cooling circuit, wherein the battery is provided that is cooled by the cooling circuit, wherein the refrigerant circuit comprises:
the compressor configured for compressing the refrigerant,
the first heat exchanger in the first branch of the refrigerant circuit through which refrigerant flows separately from coolant or conditioned air to cool the conditioned air for an air-conditioned space,
the second heat exchanger in the second branch of the refrigerant circuit that is parallel to the first branch, and through which the coolant flows separately from the refrigerant, such that the two exchange heat,
the refrigerant circuit contains a third heat exchanger, which is downstream of the compressor and upstream of the first and second heat exchangers,
the first expansion valve configured for regulating the flow of refrigerant through the first heat exchanger,
the second expansion valve configured for regulating the flow of refrigerant through the second heat exchanger,
wherein the refrigerant circuit has a maximum thermal output from the first and second heat exchangers, and
a control unit that is configured to operate the refrigerant circuit with the method according to claim 11.

21. The method according to claim 15, wherein the first limit value is between 0.5 K and 1 K, and/or the second limit value is between 0.1 K and 0.5 K.

22. The method according to claim 17, wherein the minimum (S_min) is between 1 K and 3 K, the third limit value is between 1 K and 2 K, and/or the fourth limit value is between 1 K and 2 K.

23. The method according to claim 19, wherein the fifth limit value is at least 2 K, and/or the sixth limit value is between 0.1 K and 1 K.
